(19) United States
(12) Patent Application Publication
(10) Pub. No.: US 2012/0080917 A1
(43) Pub. Date: Apr. 5, 2012

(54) MAGNETIC BUCKLE ASSEMBLIES AND ASSOCIATED METHODS FOR USE WITH CHILD SEATS AND OTHER RESTRAINT SYSTEMS

(75) Inventors: Peter E. Miller, Phoenix, AZ (US); Ian J. Hadlow, Worcester (GB); Derrick J. Barker, Bishampton (GB); Andrew C. Peters, Bromsgrove (GB); Sean L. Casey, Waterlooville (GB); Phillip Morgan, Noblesville, IN (US); Alphons L. Van Der Mullen, Beringe (NL)

(73) Assignee: AmSafe Commercial Products, Inc., Elkhart, IN (US)

(21) Appl. No.: 13/233,835

(22) Filed: Sep. 15, 2011

Related U.S. Application Data
(60) Provisional application No. 61/383,277, filed on Sep. 15, 2010.

(51) Int. Cl. B60R 22/10; B23P 17/04; B60R 22/12; H01F 7/02; B60N 2/26; B60N 2/28

(52) U.S. Cl. 297/250.1; 297/468; 264/271.1; 24/303; 29/428

(57) ABSTRACT

Magnetic buckle assemblies and associated methods of use with child seats and other restraint systems are disclosed herein. A restraint system configured in accordance with one embodiment of the present disclosure includes a first web connector and a second web connector configured to releasably engage the first web connector. The restraint system can further include a magnet positioned on at least one of the first and second web connectors. The magnet can be configured to hold the first and second web connectors together such that they can be simultaneously inserted into a corresponding buckle.

### CROSS-REFERENCE TO RELATED APPLICATION(S)

The present application claims the benefit of and priority to U.S. Provisional Patent Application No. 61/383,277, filed Sep. 15, 2010, and entitled “MAGNETIC BUCKLE ASSEMBLIES AND ASSOCIATED METHODS FOR USE WITH CHILD SEATS AND OTHER RESTRAINT SYSTEMS,” which is incorporated herein by reference in its entirety.

### TECHNICAL FIELD

The following disclosure relates generally to personal restraint systems for use in vehicles and, more particularly, to buckle assemblies and associated connectors for use with child seats and other restraint systems.

### BACKGROUND

There are many types of personal restraint systems for use in automobiles and other vehicles. Such systems include, for example, seat belts for use by adults and children of sufficient size, and child seats with associated restraints for use by toddlers and small children.

Regulations for child restraint systems often differ between countries and regions. In Europe, for example, child seat buckles are typically designed to preclude the possibility of incorrect manipulation. In general, this means that it must not be possible for the buckle to be left in a partially closed position, it must not be possible to exchange the buckle parts inadvertently when the buckle is being locked, and the buckle must only lock when all parts are engaged. Accordingly, it would be advantageous to provide child restraint systems having buckles and related components that address these design criteria.

### BRIEF DESCRIPTION OF THE DRAWINGS

FIG. 1 is an isometric view of a child secured in a seat with a restraint system having a buckle assembly and web connectors configured in accordance with an embodiment of the present disclosure.

FIG. 2A is a partially exploded top view, and FIG. 2B is a partially exploded isometric view of web connectors configured in accordance with an embodiment of the present disclosure.

FIG. 3 is an isometric view illustrating the web connectors of FIGS. 2A and 2B in an interlocked configuration.

FIGS. 4A and 4B are front and back views, respectively, of interlocked web connectors configured in accordance with another embodiment of the present disclosure.

FIGS. 4C and 4D are isometric views of an inwardly-facing side of the web connectors of FIGS. 4A and 4B.

FIG. 4E is a side cross-sectional view of the interlocked web connectors of FIGS. 4A and 4B.

FIG. 5A is a front view of interlocked web connectors configured in accordance with a further embodiment of the present disclosure.

FIGS. 5B and 5C are isometric views of an inwardly-facing side of the web connectors of FIG. 5A.

FIG. 5D is a side cross-sectional view of the interlocked web connectors of FIG. 5A.

FIGS. 6A-6F are a series of views illustrating a method of manufacturing the web connectors of FIGS. 5A-5D in accordance with an embodiment of the present disclosure.

### DETAILED DESCRIPTION

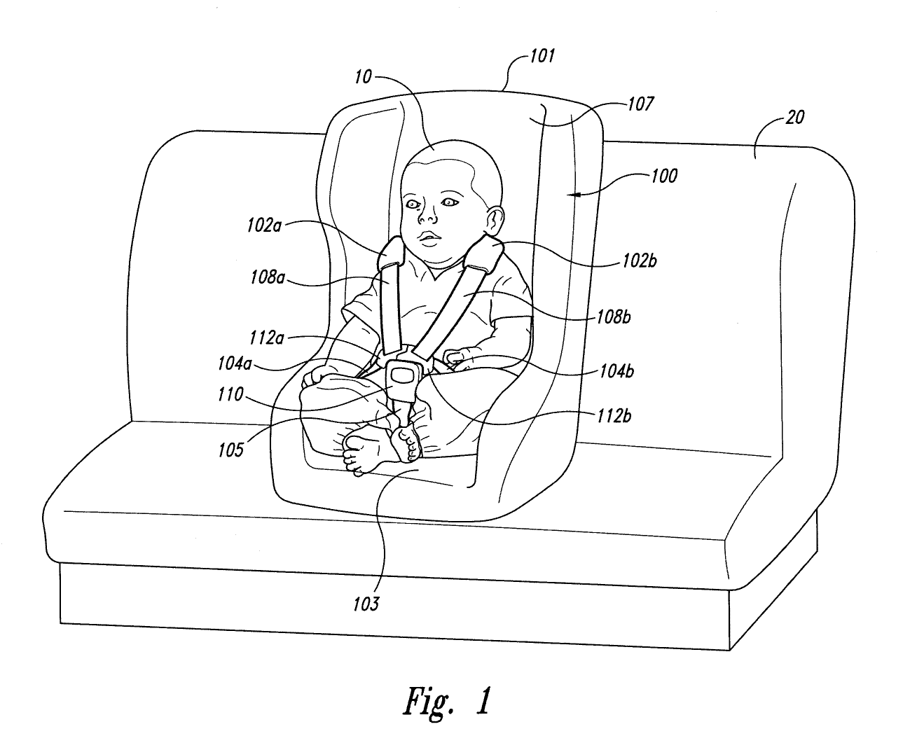

The following disclosure describes magnetic web connectors for use with child seats and other personal restraint systems in vehicles and associated buckle assemblies. As described in greater detail below, a personal restraint system configured in accordance with one aspect of the disclosure can include two web connectors with interlocking tongue portions, wherein at least one web connector includes a magnet that facilitates simultaneous engagement of the tongue portions with a corresponding buckle assembly. Certain details are set forth in the following description and in FIGS. 1-6F to provide a thorough understanding of various embodiments of the invention. However, other details describing well-known structures and systems often associated with buckle assemblies, web connectors, and/or other aspects of personal restraint systems are not set forth below to avoid unnecessarily obscuring the description of various embodiments of the invention.

Many of the details, dimensions, angles and other features shown in the Figures are merely illustrative of particular embodiments of the invention. Accordingly, other embodiments can have other details, dimensions, angles and features without departing from the spirit or scope of the present disclosure. In addition, those of ordinary skill in the art will appreciate that further embodiments of the invention can be practiced without several of the details described below. In the Figures, identical reference numbers identify identical or at least generally similar elements. To facilitate the discussion of any particular element, the most significant digit or digits of any reference number refers to the Figure in which that element is first introduced. For example, element 110 is first introduced and discussed with reference to FIG. 1.

FIG. 1 is an isometric view illustrating a restraint system 100 having a buckle assembly 110 configured in accordance with an embodiment of the disclosure. In the illustrated embodiment, the restraint system 100 holds a vehicle occupant (e.g., a child or infant 10) in a child seat 101. The child seat 101 includes a base portion 103 and a back portion 107. The child seat 101 can be secured to a vehicle seat 20 using various systems known in the art. Such systems can include, for example, belts or webs (not shown) having proximal ends attached to the child seat 101 and distal ends attached to anchors (also not shown) in the bight of the vehicle seat 20 with suitable couplings. In other embodiments, the child seat 101 can be secured to the vehicle seat 20, and/or other vehicle structures, using other suitable methods known in the art. Moreover, in further embodiments the child seat 101 or variations thereof can be reversed such that the child seat 101 faces rearward toward the vehicle seat 20.

In the illustrated embodiment, the restraint system 100 includes a first web 102a and a second web 102b extending from the back portion 107 of the child seat 101. The webs 102 can include various types of woven fabric materials and/or other suitable belt or strap materials known in the art that provide sufficient strength, flexibility, durability and/or other characteristics. In this embodiment, each of the webs 102 slidably pass through an aperture in a corresponding web connector 112 (identified individually as a first web connector 112a and a second web connector 112b). Passing the webs 102 through the web connectors 112 divides each of the webs 102 into a corresponding shoulder web portion 108 (identified individually as a first shoulder web portion 108a and a second shoulder web portion 108b), and a corresponding lap web portion 104 (identified individually as a first lap web portion 104a and a second lap web portion 104b). The lap web portions 104 extend away from each other toward opposite sides of the bight region of the child seat 101 between the back portion 107 and the seat portion 103. The end portions of the webs 102 can be secured or otherwise affixed to the child seat 101 and/or other adjacent structures using various methods known in the art.

The web connectors 112 can be releasably coupled to the buckle assembly 110 using various methods known in the art. The buckle assembly 110, for example, may require that the web connectors 112 interlock and simultaneously engage the buckle assembly 110. As described in further detail below, at least one of the web connectors 112 includes a magnet that can facilitate simultaneous insertion of the web connectors 112 into the buckle assembly 110. The buckle assembly 110 is attached to a distal end of a crotch web 105 that extends from the base portion 103 of the child seat 101. The proximal end of the crotch web 105 can be secured to the child seat 101 and/or other adjacent structures using various methods known in the art.

Although FIG. 1 illustrates one possible use of the buckle assembly 110 (e.g., use with a “five point” harness), those of ordinary skill in the art will appreciate that the buckle assembly 110, the web connectors 112, and/or the other components of the restraint system 100 can be used in a number of other restraint system applications.

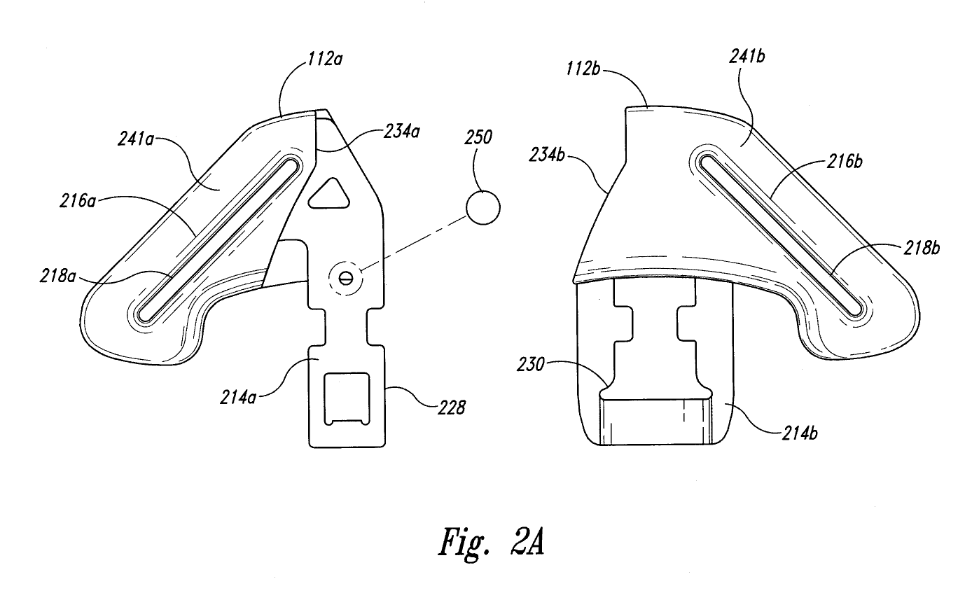

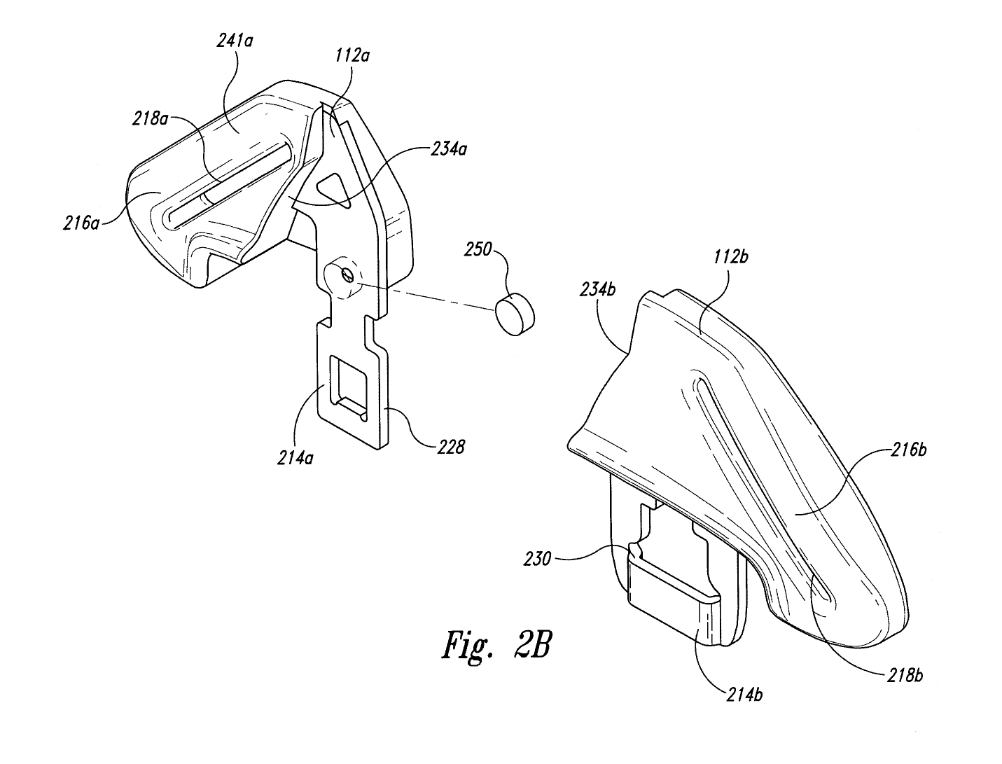

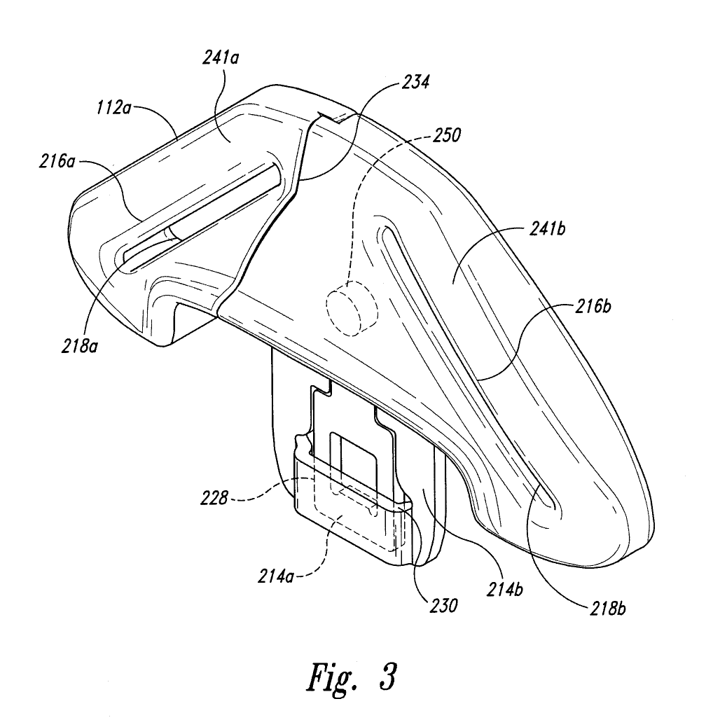

FIGS. 2A-3 are enlarged views of the web connectors 112 shown in FIG. 1. As shown in the exploded views in FIGS. 2A and 2B, each of the web connectors 112 includes a tongue portion 214 (identified individually as a first tongue portion 214a and a second tongue portion 214b) and a web receiving portion 216 (identified individually as a first web receiving portion 216a and a second web receiving portion 216b). Each of the web receiving portions 216 includes a corresponding web aperture 218 (identified individually as a first web aperture 218a and a second web aperture 218b) that can slideably receive one of the corresponding webs 102 (FIG. 1). In the illustrated embodiment, the tongue portions 214 and/or the web receiving portions 216 can be formed from suitable metallic materials, such as plate steel that is stamped or otherwise formed using suitable methods known in the art.

Each of the web connectors 112 can further include a cover 241 (identified individually as a first cover 241a and a second cover 241b) that fits over the respective web receiving portion 216 to facilitate grasping and manipulation of the web connectors 112 by the user. As shown in FIG. 3, the covers 241 can have complimentary inner edge profiles 234 that fit together when the connectors 112 are properly mated and the tongue portions 214 are interlocked. The covers 241 can be formed from textured plastic and/or other suitable materials known in the art that are bonded, press fit, and/or otherwise attached to the web receiving portions 216.

In one aspect of this embodiment, the second tongue portion 214b has one or more inner edges 230 defining an inner shape or profile that is configured to receive and releasably interlock with one or more outer edges 228 of the first tongue portion 214a which define a complementary outer shape or profile. As shown in FIG. 3, the matching shapes of the inner edges 230 and the outer edges 228 enable the two tongue portions 214 to be releasably interlocked. As those of ordinary skill in the art will appreciate, in other embodiments the edges of the first and second tongue portions 214 can have other interlocking shapes without departing from the present disclosure.

To releasably engage the web connectors 112 with the buckle assembly 110 (shown in FIG. 1), the first web connector 112a is mated to the second web connector 112b so that the respective tongue portions 214 releasably engage or interlock. Next, the interlocking tongue portions 214 are inserted through an opening in the buckle assembly 110 as a unit. The tongue portions 214 are pushed into the buckle assembly 110 until they fully engage the buckle assembly 110.

In one aspect of this embodiment, at least one of the web connectors 112 includes a magnet 250 that attracts the two web connectors 112 together to facilitate the interlocking of the two tongue portions 214. The magnet 250 can comprise a material having sufficient magnetic force to attract and secure the first web connector 112a to the second web connector 112b without interfering with the latching or unlatching of the tongue portions 214. In some embodiments, for example, the magnet 250 can comprise a ferrite magnetic material, a neodymium magnetic material, and/or other suitable magnetic materials.

As illustrated by the phantom lines in FIGS. 2A and 2B, the magnet 250 can be affixed to the first tongue portion 214a such that the magnet 250 forms a magnetic attraction to the second tongue portion 214b. In further embodiments, the magnet 250 can be affixed proximate to another surface portion (e.g., the second tongue portion 214b, the web receiving portion 216, and/or the cover 241) of one of the web connectors 112 such that the magnet 250 forms a magnetic attraction to the other web connector 112.

In the embodiment shown in FIG. 3, the magnet 250 is embedded in the first tongue portion 214a of the first web connector 112. In further embodiments, the magnet 250 can be affixed proximate to other surfaces of the web connectors 112 using permanent bonding, stamping, snapping, molding and/or another method known to those skilled in the art. In still further embodiments, the web connectors 112 can be retrofitted with the magnet 250 using adhesives, snaps, fasteners, and/or other attachment mechanisms known in the art.

In the embodiment illustrated in FIGS. 2A-3, the magnet 250 is a cylinder. In other embodiments, the magnet 250 can have any suitable shape or size for attracting the two web connectors 112 together, such as a cuboid, a sphere, etc. In further embodiments, the tongue portion 214 and/or the web receiving portion 216 can comprise a magnetic material, such as iron, nickel, lodestone, etc.

The magnet 250 attracts the two web connectors 112 together to simplify alignment and interlocking of the two the tongue portions 214 prior to insertion into the buckle assembly 110. In FIG. 3, for example, the magnet 250 on the first web connector 112a attracts the second web connector 112b such that the tongue portions 214 are urged together and easily interlock. In various embodiments, the buckle assembly 110 can include a Hall effect sensor (not shown) to indicate that the buckle assembly 110 has been latched. The Hall sensor, for example, can detect the presence of a magnetic field from the magnet 250 when the tongue portions 214 are properly positioned within the buckle assembly 110.

In a further embodiment, the first and second web connectors 112 can both include a magnet (e.g., the magnet 250 described above). The dual magnets can further increase the magnetic attraction between the web connectors 112, thereby increasing the force interlocking the tongue portions 214. In this embodiment, both web connectors 112 can also releasably attach to a metallic portion (e.g., a steel frame) of a child seat (e.g., the child seat 101 shown in FIG. 1) when the restraint system 100 is not in use. Attaching the web connectors 112 to peripheral portions of the child seat 101 can facilitate unobstructed loading of a vehicle occupant (e.g., the infant 10 in FIG. 1) into the child seat 101. Additionally, attaching the web connectors 112 to corresponding sides of the child seat 101 can prevent the webs 102 from tangling when they are not in use and orient the restraint system 100 for the occupant and/or the user loading the occupant.

Although FIGS. 2A-3 illustrate one possible use of the magnet 250 (e.g., use with interlocking web connectors 112), those of ordinary skill in the art will appreciate that the magnet 250 can be used with a number of other web connectors and buckle assemblies and/or other occupant and non-occupant restraint systems. In other embodiments, for example, the magnetic buckle assembly 110 can be used to restrain a child in a high-chair, swing, bicycle, stroller, or other seat.

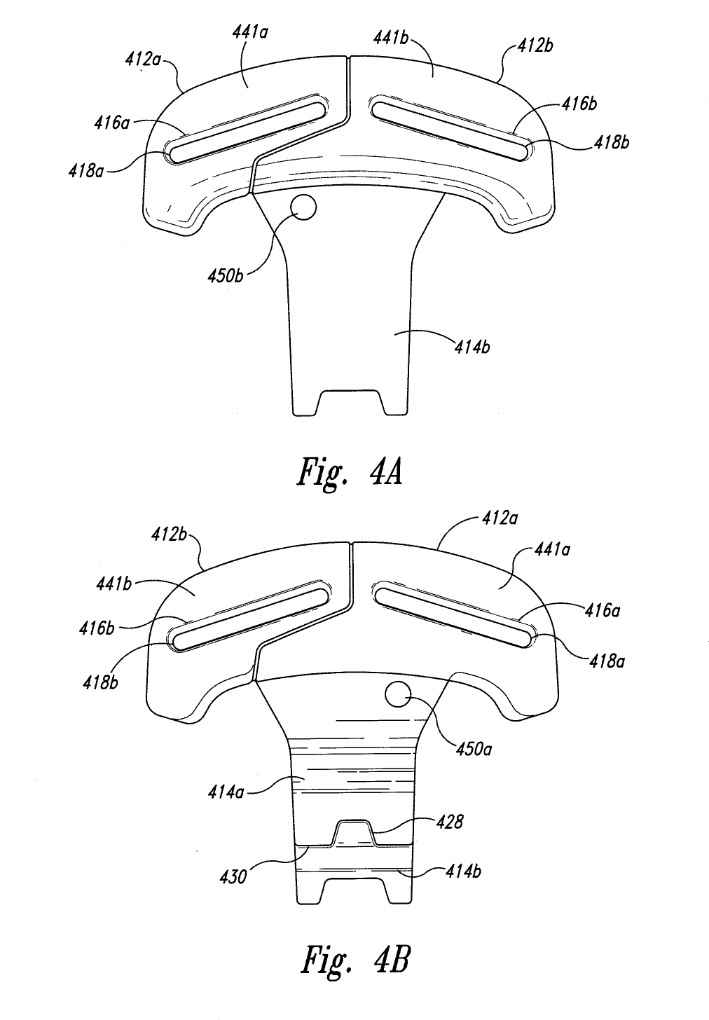

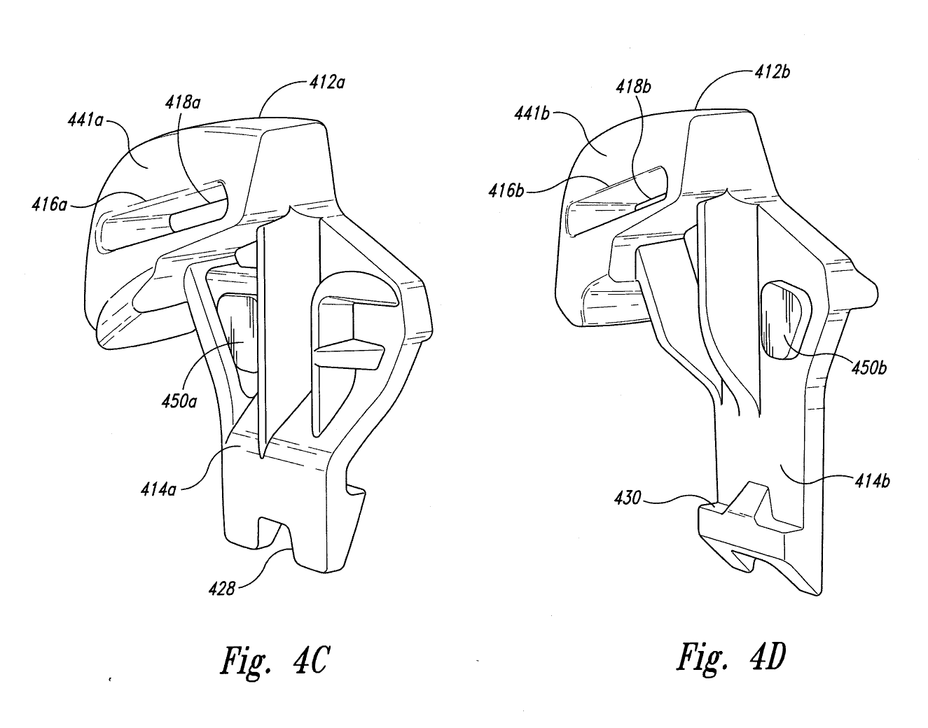

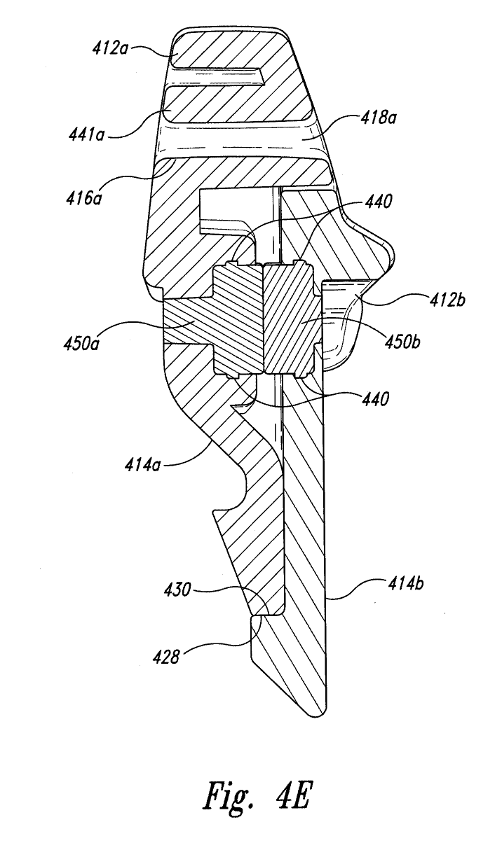

FIGS. 4A and 4B are front and back views, respectively, of interlocked web connectors 412 (identified individually as a first web connector 412a and a second web connector 412b) configured in accordance with another embodiment of the present disclosure. The web connectors 412 can include features generally similar in structure and function to the corresponding features of the web connectors 112 described above with reference to FIGS. 2A-3. The web connectors 412, for example, include tongue portions 414 (identified individually as a first tongue portion 414a and a second tongue portion 414b) that have interlocking outer and inner edges 428 and 430 (FIG. 4B) and web receiving portions 416 (identified individually as a first web receiving portion 416a and a second web receiving portion 416b). The web receiving portions 416 include web apertures 418 (identified individually as a first web aperture 418a and a second web aperture 418b) that can slideably receive corresponding webs. The web connectors 412 also include covers 441 (identified individually as a first cover 441a and a second cover 441b) that facilitate manual grasping of the web connectors 412. The covers 441 can be made from, e.g., a suitable plastic material (e.g., a polyamide material). The tongue portions 414 and/or other portions of the web connectors 412 can be made from, e.g., a suitable plastic material, a suitable metal material (e.g., similar to the tongue portions 214 of FIGS. 2A-3), and/or other suitable materials known in the art.

In the illustrated embodiment, the first and second tongue portions 414a and 414b include corresponding first and second magnets 450a and 450b that attract the two web connectors 412 together and facilitate aligning and interlocking the tongue portions 414. The magnets 450 can be made from any suitable magnetic material, such as ferrite magnetic materials and neodymium magnetic materials. In one aspect of the illustrated embodiment, the magnets 450 are visible from the front and back of the interlocked tongue portion 414. In other embodiments, however, the magnets 450 can be hidden or covered by the tongue portions 414 and/or other portions of the web connectors 412.

FIGS. 4C and 4D are isometric views of inwardly-facing sides of the first and second web connectors 412a and 412b, respectively, of FIGS. 4A and 4B. In this embodiment, an inner portion of each magnet 450 protrudes outwardly from the inside of the tongues 414, and is therefore visible to a user. In other embodiments, however, one or both of the magnets 450 can be at least substantially embedded within the tongue portions 414.

FIG. 4E is a side cross-sectional view of the interlocked web connectors 412 of FIGS. 4A and 4B. In the illustrated embodiment, the protruding inner portions of the magnets 450 directly contact one another, but in other embodiments an intermediate material can be positioned between the magnets 450. During engagement of the tongue portions 414, the magnets 450 urge the web connectors 412 together and into alignment with respect to one another such that the outer surface 428 of the first tongue portion 414a mates with the inner surface 430 of the second tongue portion 414b. The magnets 450 can lightly hold the two tongue portions 414 together such that they can be simultaneously inserted into a corresponding buckle assembly (e.g., as required by European standards) with one hand, leaving the other hand free to adjust the restraint system or child. Additionally, the two magnets 450 allow the web connectors 412 to be attached to peripheral elements of a child seat (e.g., the child seat 101 of FIG. 1) while a child is loaded and unloaded from the seat.

In various embodiments, the magnets 450 and the web connectors 412 can be formed by molding and/or other suitable formation processes. For example, a magnetic material and a plastic resin can be injected into a mold to form the magnetic tongue portions 414 shown in FIGS. 4A-4D. When ferrite magnetic materials are used for the magnet 450, other magnets can be embedded in the molding tool to magnetize the magnetic material during the molding process. When neodymium magnetic materials are used, the magnetic material can be magnetized either before or after it is molded into the tongue portions 414. Regardless of the timing of magnetization, molding the material of the tongue portions 414 over and/or around the magnets 450 securely holds or bonds the magnets 450 to the tongue portions 414. In another aspect of the illustrated embodiment, the magnets 450 include mechanical holding features 440 (e.g., a lip, ridge, etc.; FIG. 4E) that protrude outwardly into the corresponding tongue portions 414 and further secure the magnets 450 to the web connectors 412. Alternatively, the magnets 450 can be secured by grooves or other recesses in the magnets 450.

In other embodiments, the magnets 450 can be formed in the tongue portions 414 and/or other portions of the web connectors 412 using suitable methods. In one embodiment, for example, the magnets 450 can be positioned within recesses in the covers 441 and glued, snapped, and/or otherwise secured in place. In another embodiment, the web connectors 412 can be made partially of metal (e.g., similar to the tongue portions 214 of FIGS. 2A-3) and stamped or otherwise formed into suitable interlocking shapes.

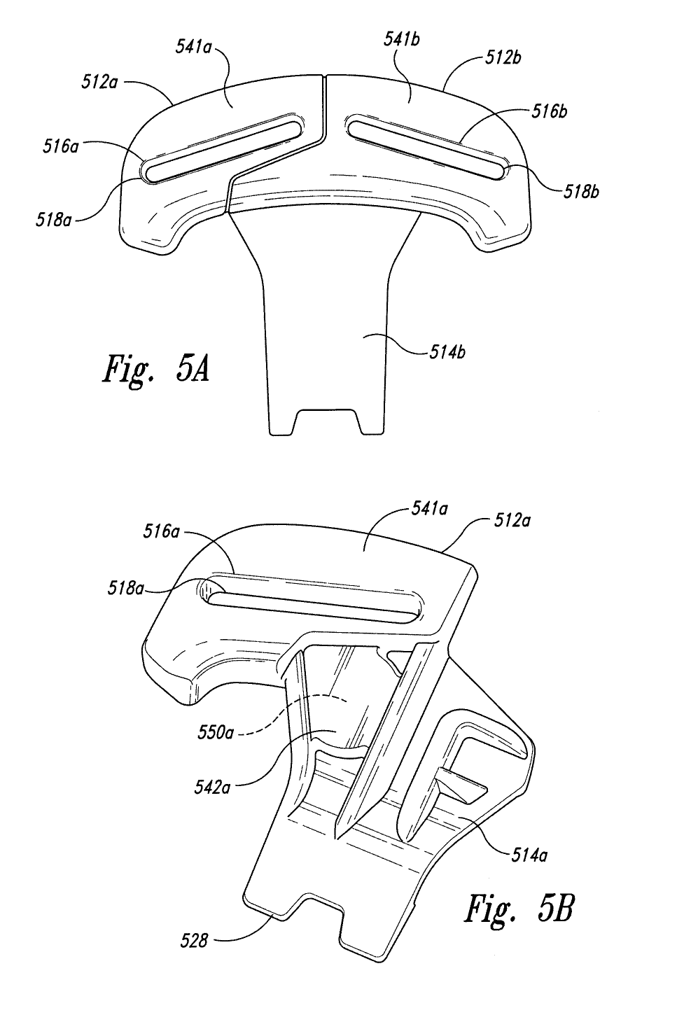

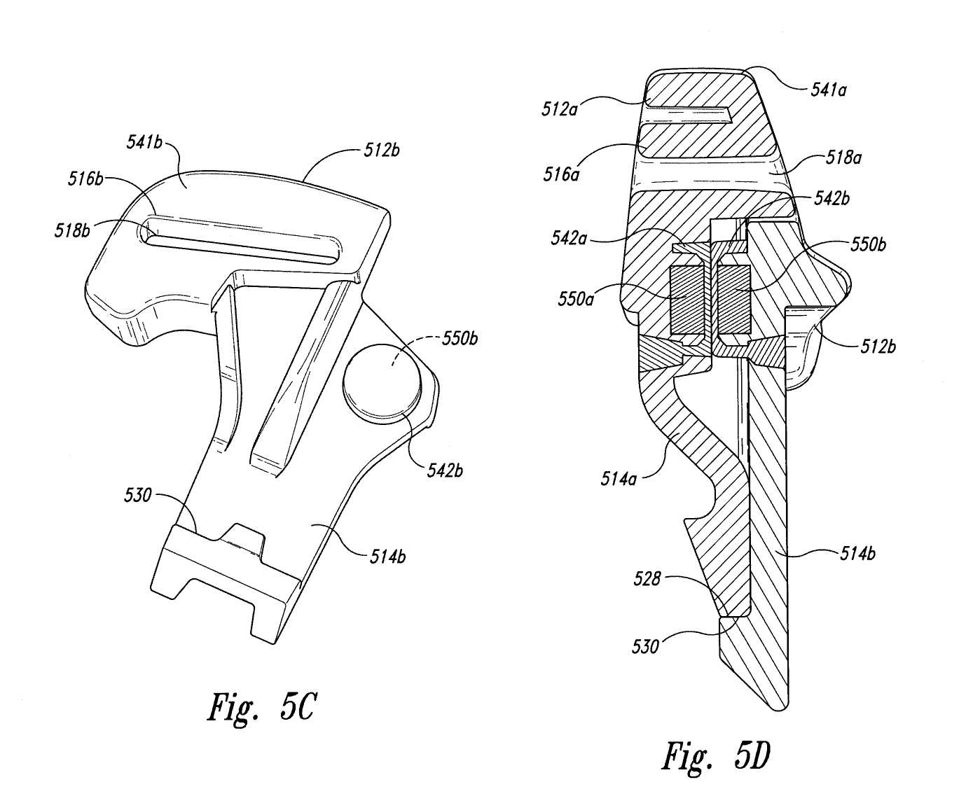

FIG. 5A is a front view of interlocked web connectors 512 (identified individually as a first web connector 512a and a second web connector 512b) configured in accordance with a further embodiment of the present disclosure. FIGS. 5B and 5C are isometric views of an inwardly-facing side of the web connectors 512 of FIG. 5A, and FIG. 5D is a side cross-sectional view of the interlocked web connectors 512 of FIG. 5A. The web connectors 512 include features generally similar to those of the web connectors 412 illustrated in FIGS. 4A-4E. The web connectors 512, for example, include two tongue portions 514 (identified individually as a first tongue portion 514a and a second tongue portion 514b) having magnets 550 (identified individually as a first magnet 550a and a second magnet 550b) that hold the tongue portions 514 together to facilitate simultaneous insertion into a corresponding buckle assembly.

In the embodiment illustrated in FIGS. 5A-5D, the magnets 550 are encased by portions of the web connectors 512 such that they are not visible from the front side of the interlocked web connectors 512 (FIG. 5A) or from the backside of the web connectors 512 (FIGS. 5B and 5C). As shown in FIG. 5B, for example, the first magnet 550a can be embedded in the first web connector 512a and encapsulated, housed, or enclosed by a first magnet cover or overmold 542a such that the first magnet 550a is flush with an inner surface of the first web connector 512a. As shown in FIG. 5C, the second magnet 550b can protrude from an inner surface of the second web connector 512b, and can be encased by a second magnet cover or overmold 542b. In other embodiments, both the first and second magnets 550a and 550b can be embedded in the corresponding web connectors 512 or both magnets 550 can protrude from inner surfaces of the web connectors 512. As shown in FIG. 5D, the magnet overmolds 542 can encircle at least a portion of the magnets 550 to fasten the magnets 550 to the web connectors 512.

In various embodiments, the magnet covers 542 can be made from a material that can be formed over the magnets 550, while still allowing the magnets 550 to attract the tongue portions 514 together. In one embodiment, for example, the magnet overmolds 542 are molded from a plastic resin. In further embodiments, the magnet overmolds 542 and the web connectors 512 can be formed from the same material and/or different materials.

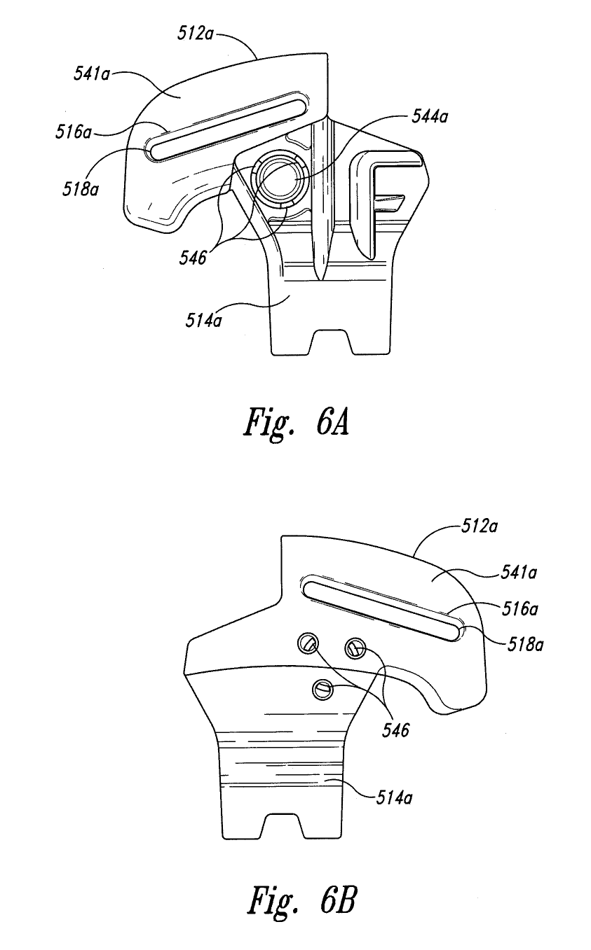

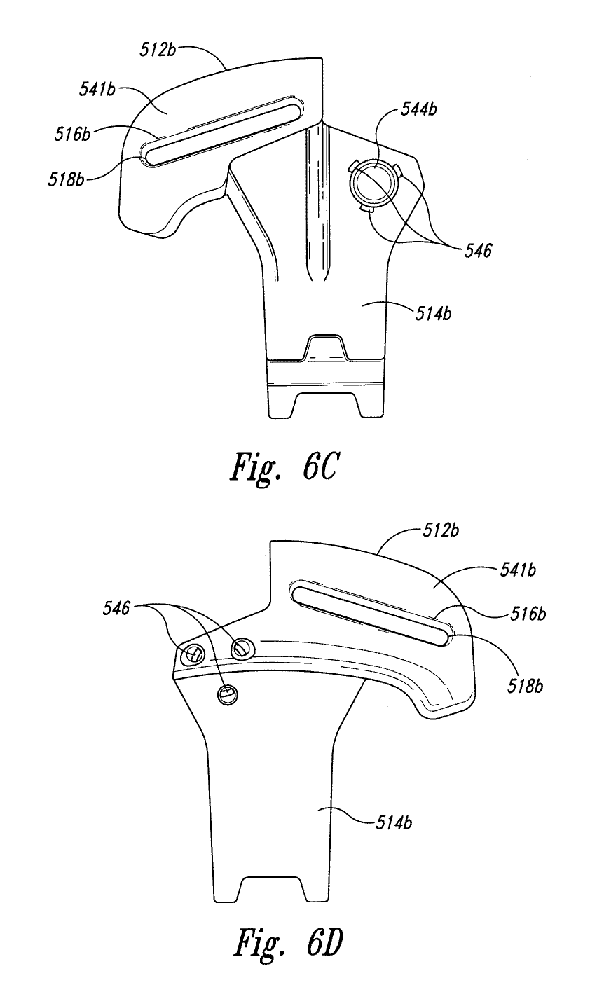

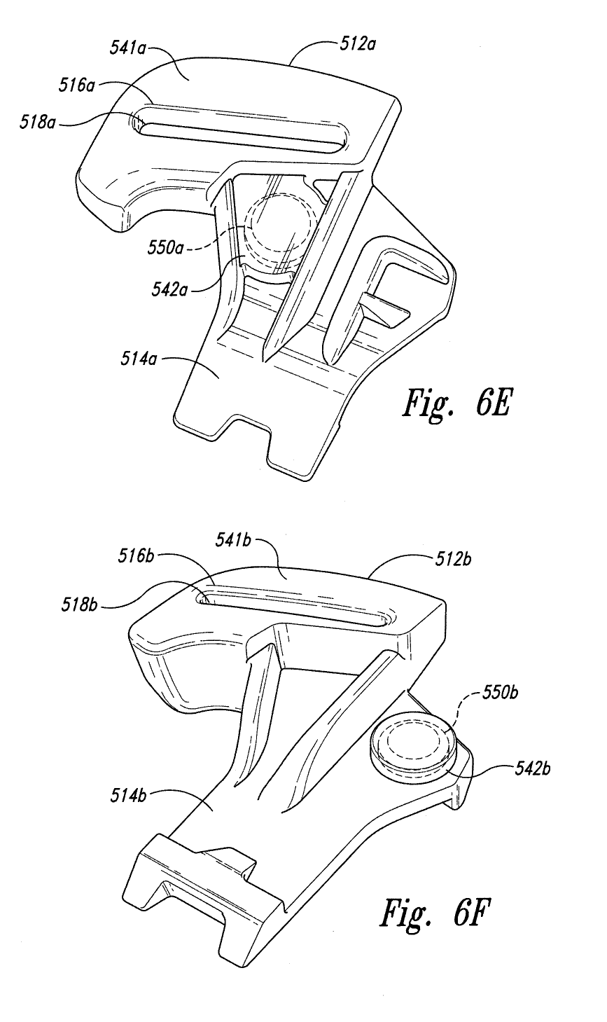

FIGS. 6A-6F are a series of views illustrating a method of manufacturing the web connectors 512 of FIGS. 5A-5D. FIGS. 6A and 6B, for example, illustrate the front and back of the first web connector 512a, respectively, after it has been partially formed. The first web connector 512a can be molded, stamped, and/or otherwise formed from a plastic resin, a metal material, and/or other suitable materials. In other embodiments, the web connectors 512 can be formed using other molding techniques and/or other suitable formation methods.

In one aspect of the illustrated embodiment, the first web connector 512a includes an embedded first platform 544a on which the first magnet 550a (FIG. 6D) can be mounted. A plurality of through-holes or openings 546 can be positioned around the first platform 544a through which a molding material (e.g., a plastic resin) can be formed to mechanically lock or otherwise secure the first magnet 550a in position. As shown in FIGS. 6C and 6D, the second web connector 512b, can include features generally similar to those of the first web connector 512a of FIGS. 6A and 6B, such as a second platform 544b surrounded by openings 546 that can be used to fasten the second magnet 550b (FIG. 6E) to the second web connector 512b. As shown in FIG. 6C, the second platform 544b can be raised from the inner surface of the second tongue portion 514b. In other embodiments, the platforms 544 are both embedded or raised.

FIGS. 6E and 6F illustrate the first and second web connectors 512a and 512b, respectively, after the magnets 550 have been positioned on the platforms 544 and the magnet overmolds 542 have been formed over the magnets 550. When neodymium magnetic materials are used, the magnets 550 can be magnetized before they are mounted on the platforms 544. Once mounted, the magnets 550 can be overmolded with a plastic resin (e.g., a polyamide resin) and/or other suitable material via injection molding or other suitable molding processes to form the magnet overmolds 542. The magnet overmolds 542 can secure the magnets 550 in the tongue portions 514 and hide them such that they are not easily removed from the web connectors 512. In further embodiments, a cover or cap can be used to enclose the magnets, and protrusions from the cap can be inserted into the openings 546 to secure the cap over the magnet 550.

From the foregoing, it will be appreciated that specific embodiments of the disclosure have been described herein for purposes of illustration, but that various modifications may be made without deviating from the spirit and scope of the various embodiments of the disclosure. In various embodiments, for example, the web connectors described with reference to FIGS. 4A-6F can include the Hall effect sensor described with reference to FIGS. 2A-3. Additionally, the magnets described above are positioned substantially within the tongue portions of the web connectors. However, in other embodiments, the magnets can be positioned in other portions of the web connectors. In various embodiments, each web connector can include more than one magnet and/or the magnets can have shapes other than those shown in the Figures. Further, while various advantages associated with certain embodiments of the disclosure have been described above in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. A personal restraint system for use in a vehicle, comprising:
a first web connector;
a second web connector; and
a magnet positioned on one of the first and second web connectors, wherein the magnet is configured to hold the first and second web connectors together for simultaneous insertion into a buckle.

2. The personal restraint system of claim 1 wherein the magnet comprises at least one of a ferrite magnetic material and a neodymium magnetic material.

3. The personal restraint system of claim 1 wherein the first web connector is configured to releasably engage the second web connector.

4. The personal restraint system of claim 3 wherein the magnet is visible when the first and second web connectors are engaged.

5. The personal restraint system of claim 1 wherein the magnet protrudes from an inner surface of the first web connector.

6. The personal restraint system of claim 1 wherein the magnet is retained by at least one mechanical holding feature.

7. The personal restraint system of claim 1 wherein the magnet is covered by a magnet overmold.

8. The personal restraint system of claim 1 wherein:
the magnet is a first magnet carried by the first web connector; and
the personal restraint system further comprises a second magnet carried by the second web connector.

9. The personal restraint system of claim 1 wherein:
the first web connector includes a first tongue portion;
the second web connector includes a second tongue portion; and
the magnet is mounted proximate the first tongue portion.

10. The personal restraint system of claim 1, further comprising means for releasably engaging the first and second tongue portions.

11. The personal restraint system of claim 1 wherein:
the first web connector includes a first tongue portion;
the second web connector includes a second tongue portion;
the magnet is a first magnet mounted proximate the first tongue portion; and
the personal restraint system further comprises a second magnet mounted proximate the second tongue portion.

12. The personal restraint system of claim 6 wherein the first and second tongue portions are molded over the first and second magnets, respectively.

13. The personal restraint system of claim 1 wherein:
the first web connector includes a first tongue portion having an outer edge and a first web receiving portion being configured to receive a first web;
the second web connector includes a second tongue portion having an inner edge and a second web receiving portion being configured to receive a second web, wherein the inner edge is configured to mate with the outer edge of the first tongue portion; and
the magnet includes a first magnet secured to the first web connector and a second magnet secured to the second web connector, wherein the first and second magnets are positioned to align the outer edge of the first tongue portion to the inner edge of the second tongue portion when the first and second web connectors are coupled together.

14. The personal restraint system of claim 1 wherein:
the magnet is a first magnet secured to the first web connector; and
the personal restraint system further comprises—
a second magnet secure to the second web connector; and
a child seat having a peripheral portion, a first web coupled to the first web connector, and a second web coupled to the second web connector, wherein the first and second magnets are configured to releasably couple the first and second web connectors to the peripheral portion.

15. A personal restraint system for use in a vehicle, comprising:
a web assembly; and
at least two web connectors coupled to the web assembly, wherein at least one web connector includes a magnet that facilitates simultaneous engagement of the tongue portions with a corresponding buckle assembly.

16. The personal restraint system of claim 15 wherein the web connectors include releasably interlocking tongue portions.

17. The personal restraint system of claim 15 wherein:
the at least two web connectors include a first web connector and a second web connector having corresponding first and second tongue portions;
the first and second tongue portions comprise a nonmagnetic material;
the magnet is a first magnet coupled to the first tongue portion; and
the personal restraint system further comprises a second magnet coupled to the second tongue portion.

18. The personal restraint system of claim 17 wherein at least one of the first magnet and the second magnet are mechanically secured to the corresponding first and second web connectors.

19. The personal restraint system of claim 17 wherein at least one of the first and second magnets are embedded in the corresponding first and second web connectors.

20. The personal restraint system of claim 17, further comprising a child seat having a peripheral portion, a first web coupled to the first web connector, and a second web coupled to the second web connector, wherein the first and second magnets are configured to releasably attach the first and second web connectors to the peripheral portion.

21. The personal restraint system of claim 15 wherein the magnet is covered by a plastic overmold.

22. The personal restraint system of claim 15 wherein:
the at least two web connectors include a first web connector and a second web connector;
the first web connector includes a first tongue portion;
the second web connector includes a second tongue portion; and
the personal restraint system further includes means for engaging the first tongue portion with the second tongue portion.

23. The personal restraint system of claim 15, further comprising means for mechanically securing the magnet to at least one of the web connectors.

24. A method of manufacturing a personal restraint system for use in a vehicle, the method comprising:
forming a first web connector;
forming a second web connector configured to releasably cooperate with the first web connector; and
coupling a magnet to one of the first and second web connectors, wherein the magnet is configured to hold the first and second web connectors together for simultaneous insertion into a buckle.

25. The method of claim 24 wherein:
forming the first web connector comprises molding a first tongue portion;
forming the second web connector comprises molding a second tongue portion, wherein the first and second tongue portions include interlocking surfaces; and
coupling the magnet comprises molding a first magnet in conjunction with the first tongue portion and molding a second magnet in conjunction with the second tongue portion.

26. The method of claim 25 wherein molding the first and second magnets in conjunction with the corresponding first and second tongue portions further comprises magnetizing at least one of the first and second magnets during molding.

27. The method of claim 24 wherein:
forming the first web connector comprises molding a first tongue portion;
forming the second web connector comprises molding a second tongue portion, wherein the first and second tongue portions include interlocking surfaces;
coupling the magnet comprises mounting a first magnet on a first platform on the first tongue portion and mounting a second magnet on a second platform on the second tongue portion; and
the method further comprises forming a cover over at least one of the first and second magnets.

28. The method of claim 27 wherein forming a cover over at least one of the first and second magnets comprises molding a plastic resin through openings surrounding the first platform of the first tongue portion.

29. The method of claim 24 wherein coupling the magnet comprises mechanically securing the magnet to at least one of the first and second web connectors.

30. The method of claim 24 wherein coupling the magnet comprises at least partially embedding the magnet in a tongue portion of the first web connector.
